(19) United States
(12) Patent Application Publication
(10) Pub. No.: US 2017/0173780 A1
(43) Pub. Date: Jun. 22, 2017

(54) MULTI-FUNCTIONAL TOOLBOX

(71) Applicant: Yih Cheng Factory Co., Ltd, Taichung (TW)

(72) Inventor: Jack Lin, Taichung (TW)

(21) Appl. No.: 14/975,837

(22) Filed: Dec. 20, 2015

(51) Int. Cl. B25H 3/02

(52) U.S. Cl. CPC B25H 3/021

(57) ABSTRACT

A multi-functional toolbox includes at least one storage unit and a connector detachably connected to the storage unit. The storage unit includes a box and a cover movable relative to the box between a first position and a second position. In the first position, the cover closes the box. In the second position, the cover opens the box.

### BACKGROUND OF INVENTION

1. Field of Invention

The present invention relates to tools and, more particularly, to a multi-functional toolbox.

2. Related Prior Art

A worker often carries various tools such as a magnet charger/eraser, an eraser, screwdrivers, a chuck, a connecting rod, an electric tool and a pneumatic tool to work. These tools are often carried in a toolbox.

In practice, screws are often dropped onto the floor, causing troubles for workers. To solve this problem, the magnet charger/eraser and a screwdriver are taken from the tool box and the magnet charger/eraser is used to charge the screwdriver with magnetism. Thus, the screwdriver attracts screws during tightening and/or slackening. After the tightening and/or slacking, the magnet charger/eraser is used to erase the magnetism from the screwdriver. After the erasing, the magnet charger/eraser and the screwdriver are returned in the toolbox. However, the charging and erasing are troublesome for the worker.

To solve the previous problem, a toolbox is disclosed in Taiwanese Patent No. M286759. The toolbox is adapted for containing tools, magnetically charging and erasing the tools, and measurement. The toolbox includes a box 20 and a cover 30. The box 20 includes a tool-receiving portion 25 that includes bores 23, grooves 24 and pairs of magnets 27. The grooves 24 are made in a side of the tool-holding portion 25 corresponding to the bores 23. Each bore 23 is located between the two magnets of the corresponding pair. A tool is inserted in one of the bores 23 to be magnetically charged by the magnets 27. The tool is inserted in one of the grooves 24 to be magnetically erased.

### SUMMARY OF INVENTION

It is the primary objective of the present invention to provide a convenient-to-use multi-functional toolbox.

To achieve the foregoing objectives, the multi-functional toolbox includes at least one storage unit and a connector detachably connected to the storage unit. The storage unit includes a box and a cover movable relative to the box between a first position for closing the box and a second position for opening the box.

Other objectives, advantages and features of the present invention will be apparent from the following description referring to the attached drawings.

### BRIEF DESCRIPTION OF DRAWINGS

The present invention will be described via detailed illustration of two embodiments referring to the drawings wherein:

FIG. 1 is a perspective view of a multi-functional toolbox according to the first embodiment of the present invention;

FIG. 2 is an exploded view of the multi-functional toolbox shown in FIG. 1;

FIG. 3 is a cross-sectional view of the multi-functional toolbox shown in FIG. 1;

FIG. 4 is an enlarged partial view of the multi-functional toolbox shown in FIG. 3;

FIG. 5 is a side view of the multi-functional toolbox shown in FIG. 1 in operation;

FIG. 6 is an exploded view of a multi-functional toolbox according to the second embodiment of the present invention;

FIG. 7 is a perspective view of the multi-functional toolbox shown in FIG. 6;

FIG. 8 is a cross-sectional view of the multi-functional toolbox shown in FIG. 7; and

FIG. 9 is an enlarged partial view of the multi-functional toolbox shown in FIG. 7.

### DETAILED DESCRIPTION OF EMBODIMENTS

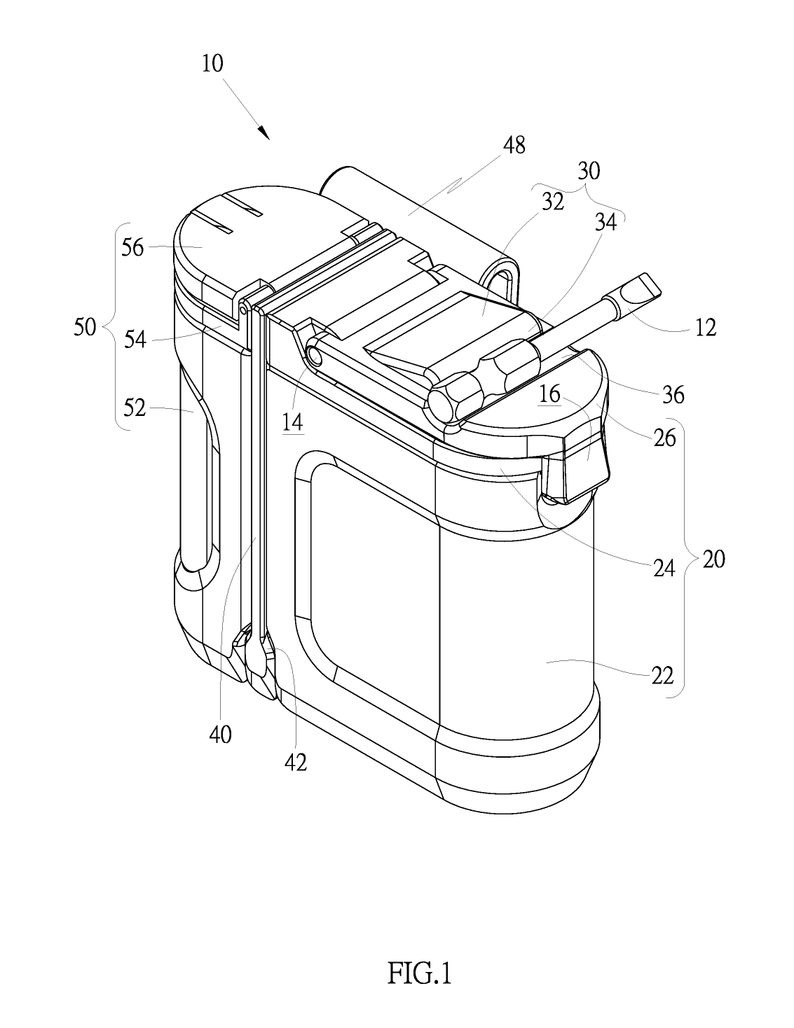

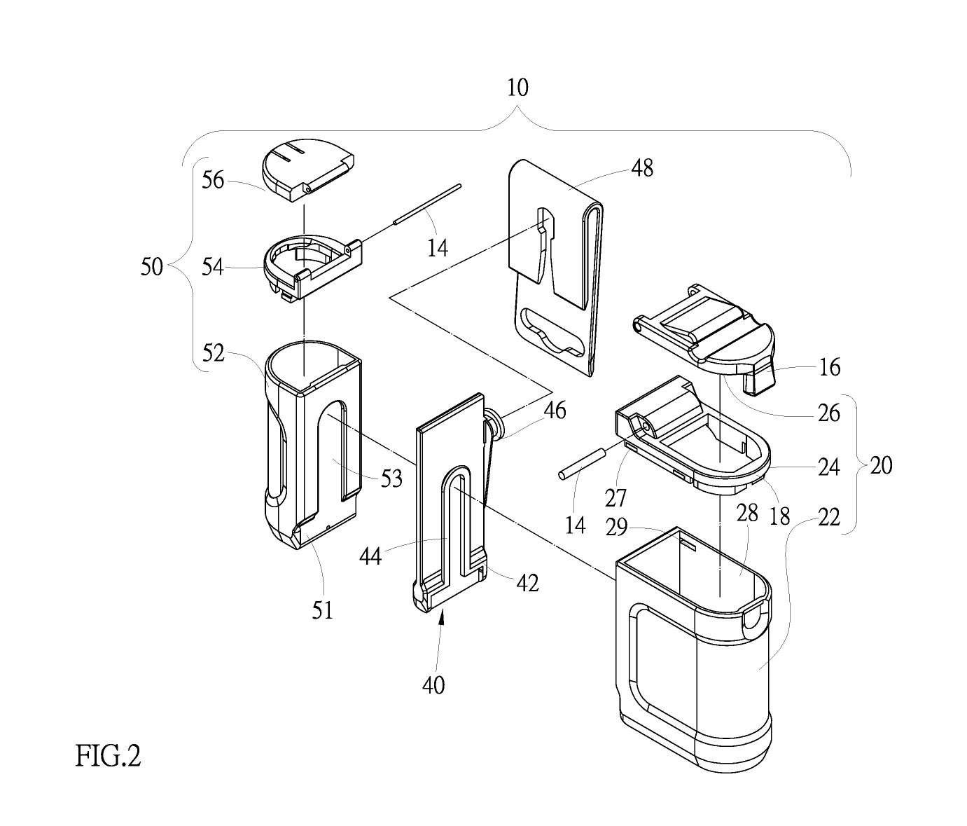

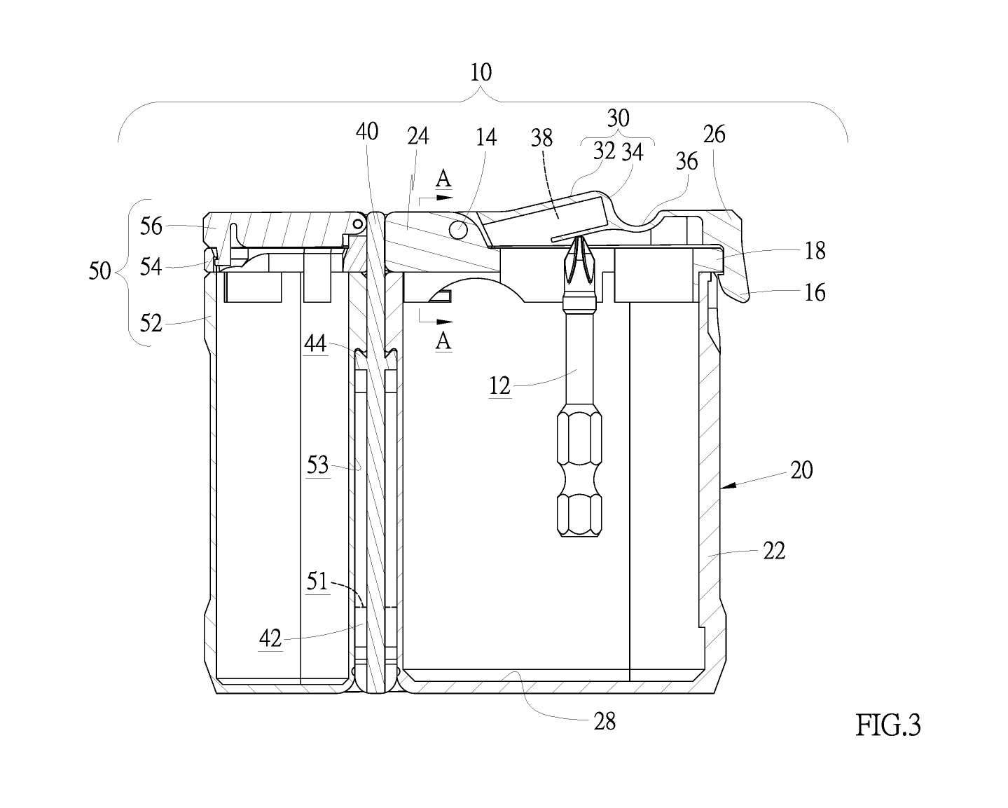

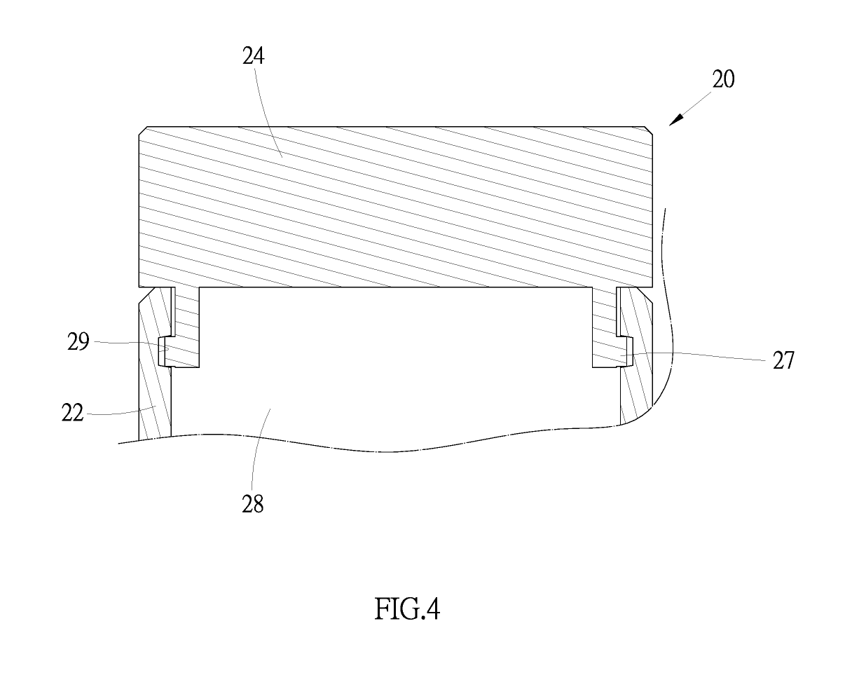

Referring to FIGS. 1 to 4, a toolbox 10 includes a primary storage unit 20, a connector 40 and a secondary storage unit 50 according to a first embodiment of the present invention.

The primary storage unit 20 includes a primary box 22, a primary tray 24 and a primary cover 26. The primary box 22 includes a space 28 for containing various screwdrivers 12 so that the screwdrivers 12 can easily be carried. The primary box 22 further includes grooves 29 in an internal face, in communication with the space 28.

The primary tray 24 is an annular element inserted in an opening of the primary box 22. The primary tray 24 includes a latch 18 formed on a front portion and ribs 27 formed on a lower portion. The ribs 27 can be inserted in the grooves 29 to keep the primary tray 24 on the primary box 22.

The primary cover 26 includes a buckle 16 formed on a front portion. A rear portion of the primary cover 26 is pivotally connected to the primary tray 24 via a pivot 14. Thus, the primary cover 26 can be pivoted between two positions.

In the first position, the primary cover 26 closes a space defined in the primary tray 24 and the space 28 of the primary box 22 to keep the screwdrivers 12 in the primary storage unit 20. The buckle 16 of the primary cover 26 can be engaged with the latch 18 of the primary tray 24 to keep the primary cover 26 in the first position.

A force can used to pivot the primary cover 26 about the pivot 14 to disengage the buckle 16 from the latch 18 and move the primary cover 26 to the second position from the first position. In the second position, the primary cover 26 opens the primary tray 24 and the primary box 22 to allow any of the screwdrivers 12 to be selectively inserted in or removed from the primary storage unit 20.

The primary cover 26 further includes a protrusion 30, two slopes 32 and 34 and a recess 36. The protrusion 30 is formed on an upper face of the primary cover 26. The first slope 32 is formed on a rear portion of the protrusion 30. The second slope 34 is formed on a rear portion of the protrusion 30. The first slope 32 and the second slope 34 are like two sides of a triangle in a side view of the toolbox 10. The recess 36 is made in the upper face of the primary cover 26. The recess 36 is defined by a concave face near the protrusion 30. The recess 36 is located next to the second slope 34.

The protrusion 30 is a hollow portion adapted for containing a magnet 38. The magnet 38 can be a permanent magnet or an electric magnet. Two poles of the magnet 38 are located on two sides of the protrusion 30. That is, one of the poles of the magnet 38 is located near the first slope 32 while the other pole of the magnet 38 is located near the second slope 34.

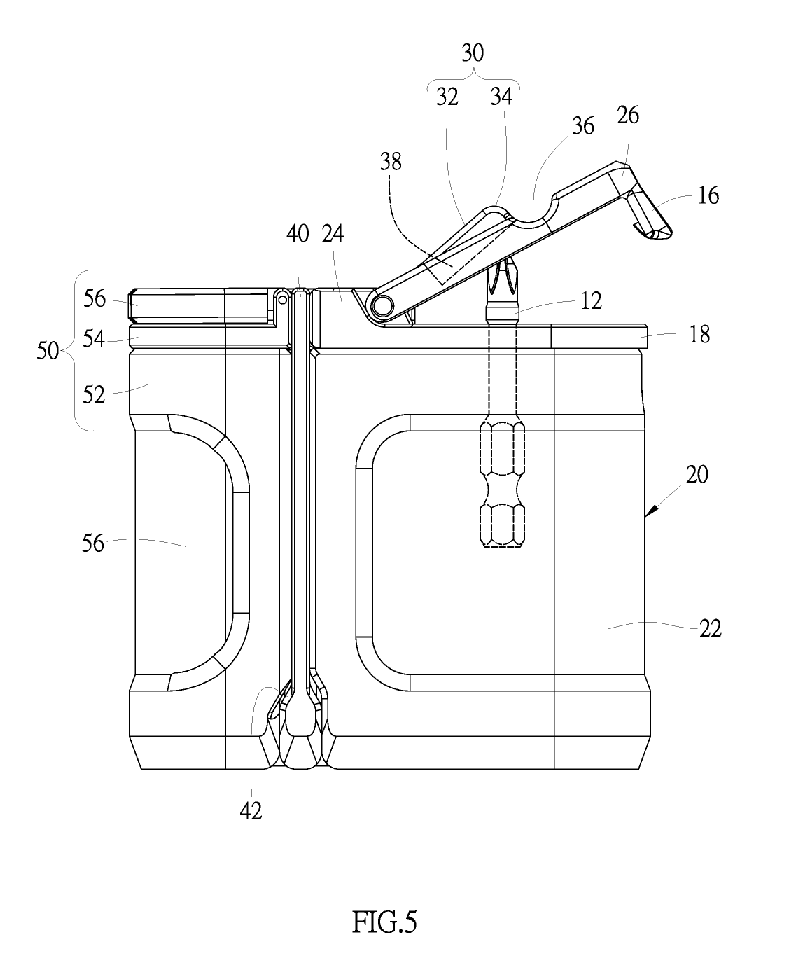

To use the magnet 38, the primary cover 26 is located in the first position, and the primary storage unit 20 is shaken. Hence, the screwdrivers 12 contained in the primary box 22 are attracted to a lower face of the primary cover 26 by the magnet 38. Then, referring to FIG. 5, the primary cover 26 is pivoted to the second position, and the screwdrivers 12 attached to the lower face of the primary cover 26 is moved away from the primary box 22. Hence, the screwdrivers 12 are exposed to a user who does not have to reach his or her hand in the primary box 22 via the primary tray 24 for the screwdrivers 12.

Then, the screwdriver 12 is rubbed on the first slope 32 several times so that the screwdriver 12 is magnetically charged by the magnet 38. On the contrary, a magnetically charged screwdriver 12 can be rubbed on the second slope 34, i.e., moved in the recess 36, several times so that the screwdriver 12 is magnetically erased by the magnet 38.

Referring to FIGS. 1-4, the secondary storage unit 50 includes a secondary box 52, a secondary tray 54 and a secondary cover 56. The secondary box 52 can be closed by the secondary tray 54. The secondary cover 56 is pivotally connected to the secondary tray 54 by another pivot 14 so that the secondary cover 56 can be pivoted between two positions.

The connection of the secondary tray 54 to the secondary box 52 is like the connection of the primary tray 24 to the primary box 22. The secondary cover 56 can be engaged with the secondary box 52 like the engagement of the primary cover 26 with the primary box 22.

Tools or parts to be used with the screwdrivers 12 can be stored in the secondary box 52. The use of the secondary box 52 in addition to the primary box 22 increases the functionality of the toolbox 10.

The connector 40 is used to connect the primary storage unit 20 to the secondary storage unit 50 in a detachable manner. The connection of the primary storage unit 20 to the connector 40 is like the connection of the secondary storage unit 50 to the connector 40. For briefness, the following description will be exemplarily given to the connection of the secondary storage unit 50 to the connector 40.

In this embodiment, the connector 40 is a sheet formed with a front face and a rear face. There is a horizontal protrusion 42 and a vertical protrusion 44 on the front face of the connector 40. There is another horizontal protrusion 42 and another vertical protrusion 44 on the rear face of the connector 40. On each of the front and rear faces of the connector 40, a middle portion of the horizontal protrusion 42 is connected to a lower end of the vertical protrusion 44. The vertical protrusion 44 is looks like a dovetail in a cross-sectional view.

The secondary storage unit 50 includes a horizontal recess 51 and a vertical recess 53, facing the connector 40. A middle portion of the horizontal recess 51 is in communication with a lower end of the vertical recess 53. The vertical recess 53 looks like a dovetail recess in a cross-sectional view.

The vertical protrusion 44 is inserted in the vertical recess 53 and the horizontal protrusion 42 is inserted in the horizontal recess 51 to locate the connector 40 against the secondary storage unit 50. The vertical protrusion 44 is engaged with the vertical recess 53 to prevent the connector 40 from leaving the secondary storage unit 50 horizontally since vertical protrusion 44 is a dovetail and the vertical recess 53 is a dovetail recess. However, the connector 40 can be disengaged from the secondary storage unit 50 by sliding the vertical protrusion 44 along and then out of the vertical recess 53.

The horizontal protrusion 42 is inserted in the horizontal recess 51 to position the connector 40 relative to the secondary storage unit 50. The bottom of the lower face of the connector 40 is flush with that of the secondary storage unit 50. Hence, the secondary storage unit 50 and the connector 40 look aesthetically pleasant as they are interconnected.

The foregoing description of the connection of the secondary storage unit 50 to the connector 40 and the related functions and effects is also true with the connection of the primary storage unit 20 to the connector 40. Hence, the connection of the primary storage unit 20 to the connector 40 will not be described in detail.

The connector 40 further includes a pivotal connective portion 46 for pivotally connecting a hook 48 thereto in a detachable manner. With the use of the hook 48, the toolbox 10 can be attached to a belt worn by the user. The access to the screwdrivers 12, the connection of any of the storage units 20 and 50 to the connector 40 or the detachment of any of the storage units 20 and 50 from the connector 40 is not interfered with by the pivotal connective portion 46 or the hook 48.

In another embodiment, the connector 40 can be replaced with screws or threaded bolts while screw holes are made in or nuts are buried in each of the storage units 20 and 50. Such screws or threaded bolts are inserted in such screw holes or nuts to attach the connector 40 to the storage units 20 and 50. The use of such screws or threaded bolts is safe and convenient.

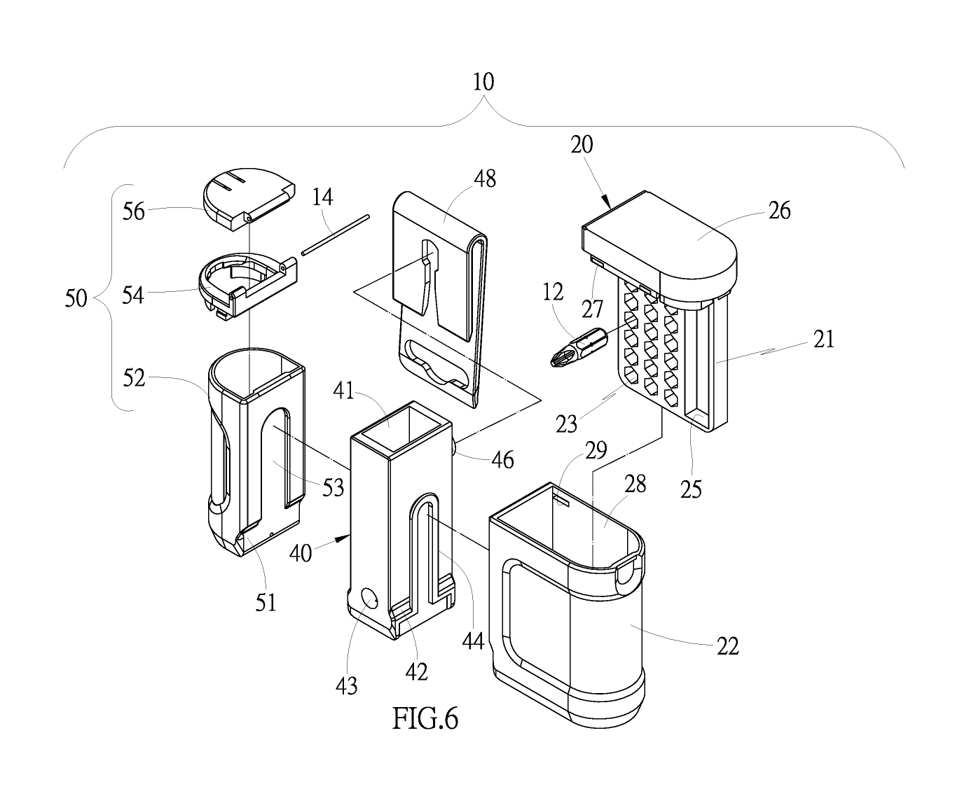

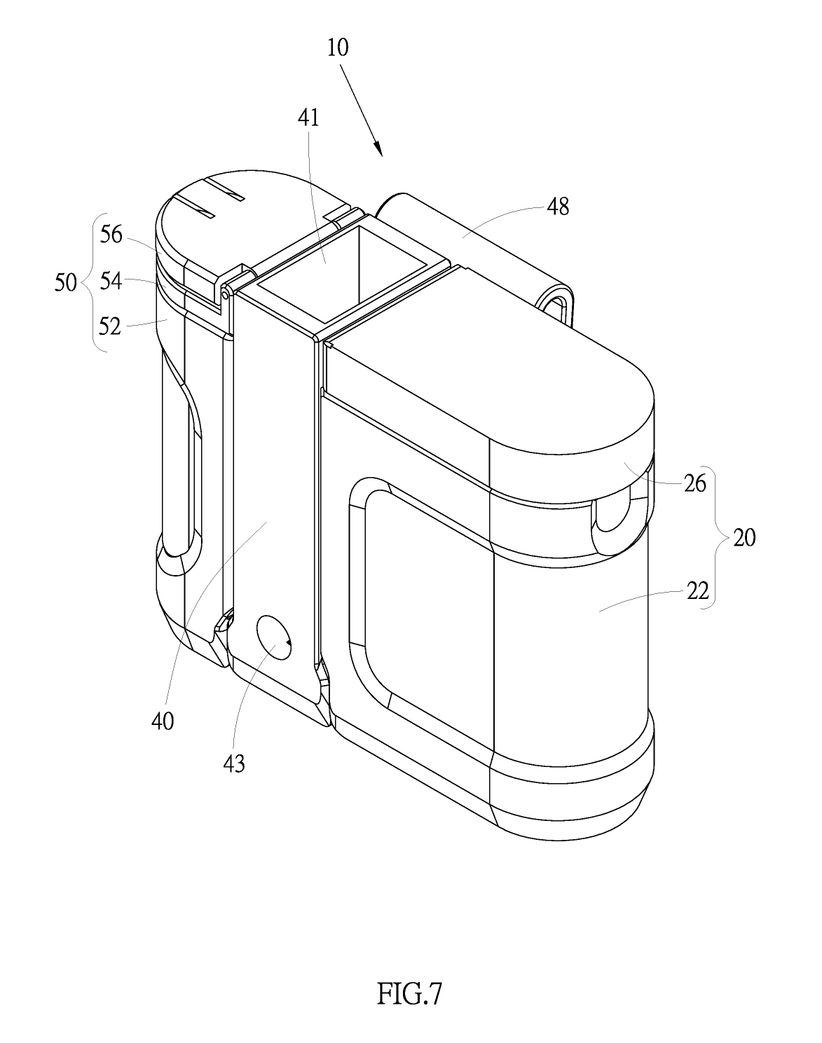

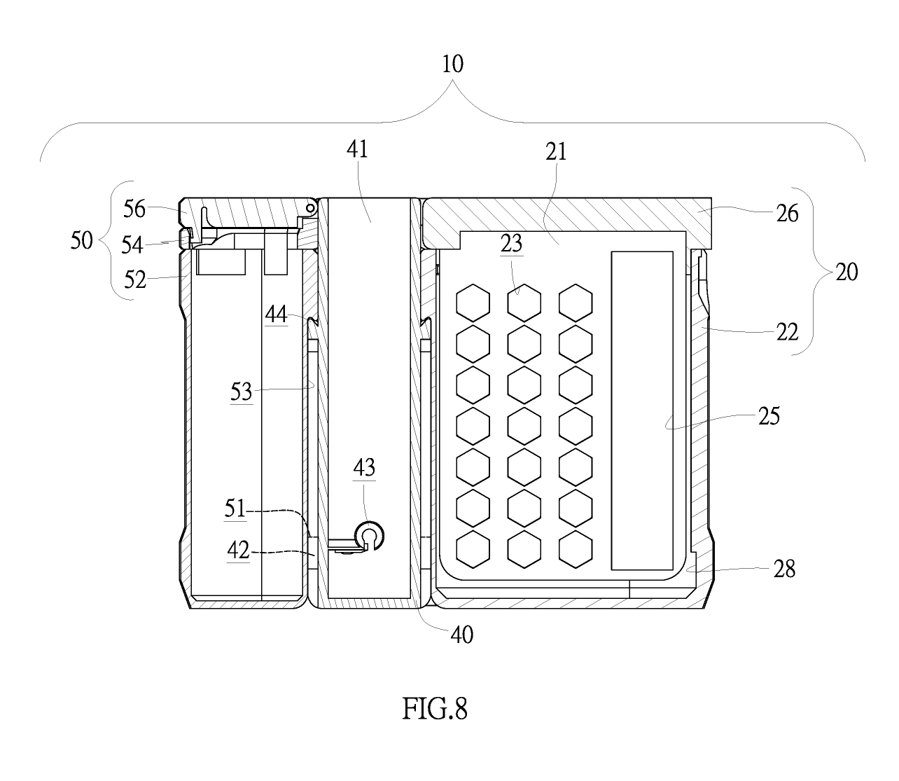

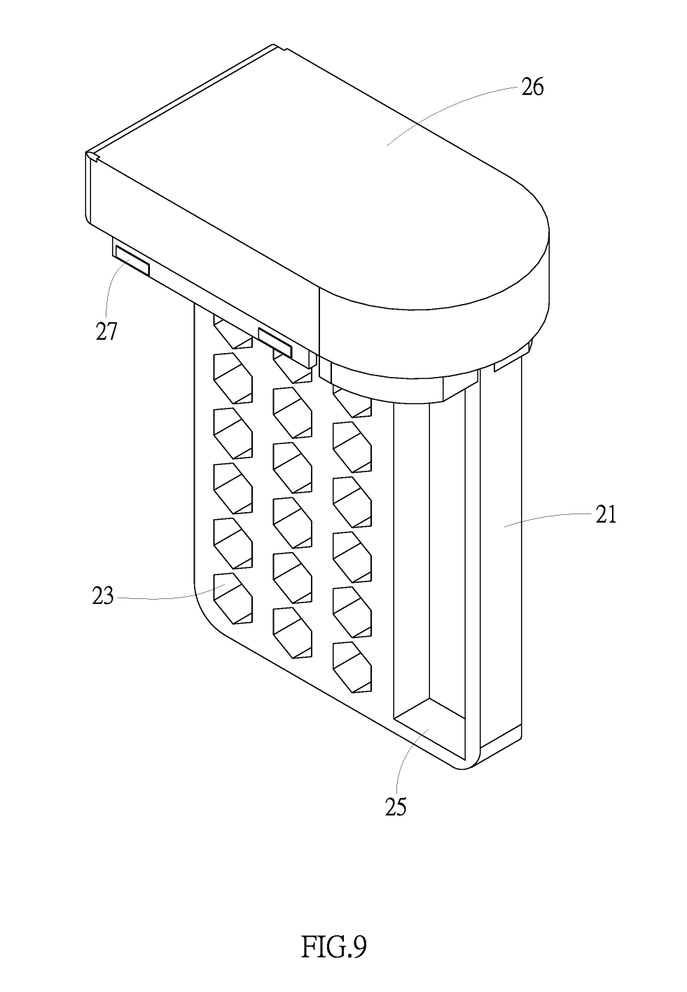

Referring to FIGS. 6 to 9, there is a toolbox 10 according to a second embodiment of the present invention. The second embodiment is like the first embodiment except for several features.

Firstly, there is no primary tray so that the primary cover 26 is not pivotally connected to any primary tray. The primary cover 26 is not pivotally connected to the primary box 22 either. Instead, the primary cover 26 and primary box 22 are adapted for direct engagement with each other. There is no protrusion, magnet, buckle or latch on or in the primary cover 26.

Secondly, there is holder 21 extending from the lower face of the primary cover 26. The holder 21 and the primary cover 26 are made in one piece. The holder 21 includes three rows of hexagonal bores 23 and a rectangular cavity 25. A screwdriver 12 can be stored in each of the bores 23. A handle that can be used to drive the screwdrivers 12 can be stored in the cavity 25.

The holder 21 is inserted in the space 28 as the primary cover 26 is engaged with the primary box 22. The holder cannot easily be shaken. The holder 21 is removed from the space 28 as the primary cover 26 is disengaged from the primary box 22. Thus, the screwdrivers 12 and the handle are exposed to the user.

Thirdly, the connector 40 is a hollow element that includes a space 41. The space 41 can be used to contain pencils, pens, markers and/or any other tool for making marks on work-pieces. Of course, the space 41 can be used to contain other objects.

Fourthly, there is a pen sharpener 43 deeply inserted in the space 41 and exposed to the exterior of the connector 40. Thus, a pencil can be inserted in and sharpened by the pen sharpener 43 while debris of the pencil can fall into the space 41. The debris of the pencil can later be thrown in a garbage bin from the space 41, and this is convenient.

The present invention has been described via detailed illustration of the embodiments. Those skilled in the art can derive variations from the embodiments without departing from the scope of the present invention. Therefore, the embodiments shall not limit the scope of the present invention defined in the claims.

1. A multi-functional toolbox comprising:
at least one storage unit comprising a box and a cover movable relative to the box between a first position for closing the box and a second position for opening the box; and
a connector detachably connected to the storage unit.

2. The multi-functional toolbox according to claim 1, wherein the cover comprises a hollow protrusion and a magnet inserted in the hollow protrusion so that two poles of the magnet are located on two sides of the hollow protrusion near the exterior of the storage unit.

3. The multi-functional toolbox according to claim 2, wherein the cover further comprises a recess near the hollow protrusion.

4. The multi-functional toolbox according to claim 3, wherein the recess is located next to the hollow protrusion.

5. The multi-functional toolbox according to claim 2, wherein the protrusion comprises two slopes like two sides of a triangle.

6. The multi-functional toolbox according to claim 1, wherein the cover comprises a holder made with bores and at least one cavity, wherein the holder is inserted in the space of the box as the cover is in the first position, wherein the holder is located out of the space of the box as the cover is in the second position.

7. The multi-functional toolbox according to claim 1, wherein the connector comprises a horizontal protrusion and a vertical protrusion, wherein the box comprises a horizontal recess for receiving the horizontal protrusion and a vertical recess for receiving the vertical protrusion when the box is connected to the connector.

8. The multi-functional toolbox according to claim 7, wherein the vertical protrusion comprises a narrow portion near the connector and a wide portion far from the connector, wherein the vertical recess comprises a narrow portion near the box and a wide portion far from the box, wherein the narrow portion of the vertical protrusion is inserted in the narrow portion of the vertical recess while the wide portion of the vertical protrusion is inserted in the wide portion of the vertical recess so that the vertical protrusion can only be removed from the vertical recess by moving the vertical protrusion along the vertical recess.

9. The multi-functional toolbox according to claim 7, wherein the vertical protrusion comprises a lower end connected to the horizontal protrusion, wherein the vertical recess comprises a lower end in communication with the horizontal recess.

10. The multi-functional toolbox according to claim 1, comprising two storage units detachably connected to the connector so that the connector is located between the storage units.

11. The multi-functional toolbox according to claim 10, wherein each of the storage units comprises a box and a cover movable relative to the box between a first position for closing the box and a second position for opening the box.

12. The multi-functional toolbox according to claim 11, wherein the connector comprises a horizontal protrusion and a vertical protrusion on each of two opposite sides, wherein the box of each of the storage units comprises a horizontal recess for receiving a corresponding one of the horizontal protrusions and a vertical recess for receiving a corresponding one of the vertical protrusions when the box is connected to the connector.

13. The multi-functional toolbox according to claim 12, wherein each of the vertical protrusions comprises a narrow portion near the connector and a wide portion far from the connector, wherein the vertical recess of each of the storage units comprises a narrow portion near the corresponding box and a wide portion far from the corresponding box, wherein the narrow portion of each of the vertical protrusions is inserted in the narrow portion of the vertical recess of the corresponding storage unit while the wide portion of each of the vertical protrusions is inserted in the wide portion of the vertical recess of the corresponding storage unit so that each of the vertical protrusions can only be removed from the vertical recess of the corresponding storage unit by moving the former along the latter.

14. The multi-functional toolbox according to claim 12, wherein each of the vertical protrusions comprises a lower end connected to the corresponding horizontal protrusion, wherein the vertical recess of each of the storage unit comprises a lower end in communication with the horizontal recess of the same.

15. The multi-functional toolbox according to claim 1, wherein the connector comprises a pivotal connective portion adapted for detachable connection to a hook without affecting the movement of the primary storage unit relative to the connector.

16. The multi-functional toolbox according to claim 1, wherein the connector is a hollow element formed with a space for containing a pen sharpener.
